(19) United States
(12) Patent Application Publication
(10) Pub. No.: US 2005/0186905 A1
(43) Pub. Date: Aug. 25, 2005

(54) Independently actuating electronic components and method of operating therefor

(76) Inventors: James L. Tracy, Coral Springs, FL (US); Joseph L. Dvorak, Boca Raton, FL (US); Sacha B. Holland, Coral Springs, FL (US); Ryan M. Nilsen, Pompano, FL (US)

Correspondence Address: AKERMAN SENTERFITT, P.O. BOX 3188, WEST PALM BEACH, FL, 33402-3188, US

(21) Appl. No.: 10/786,945

(22) Filed: Feb. 24, 2004

(51) Int. Cl. H04B 5/00; H04B 7/00; H04B 1/06

(52) U.S. Cl. 455/41.2; 455/41.1; 455/575.2

(57) ABSTRACT

A wearable electronic product (50) includes an electronic host device (52), at least one peripheral device (54) that selectively couples and decouples to the electronic host device and activates independently of the electronic host device, and means (51) for wearing the wearable electronic product by a user. The peripheral device can activate automatically (107) upon being decoupled from the electronic host device and can also activate independently (109) of any other peripheral device. In this regard, the peripheral device can automatically sense (104) the need for its own power source to become active and can optionally automatically sense the need for activating a new wireless link (108) to the electronic host device using its own power source (57) when selectively decoupled from the electronic host device.

### CROSS-REFERENCE TO RELATED APPLICATIONS

Not applicable.

### FIELD OF THE INVENTION

This invention relates generally to electronic devices, and more particularly to an electronic device that is independently actuated and operable separately from other peer level dependent devices, all while being apart from a host device.

### BACKGROUND OF THE INVENTION

The convergence of various consumer electronic products continues with such products as smart phones and cell phones with personal digital assistants. A more recent trend has been to integrate mobile communication capabilities with digital devices. Personal digital assistants (PDAs) and now digital cameras and video recorders are integrating mobile phone capabilities. For example, a digital camera could use wireless data communication to share photos with others having a similar device or anyone having an email account. An MP3 player integrated with a mobile phone device and strapped to a user's arm while jogging or exercising enables the user to make and receive phone calls with the same device that allows them to listen to music. Unfortunately, such devices are typically costly, unnecessarily large, and limited to their intended usage as an integrated device. These consumer products have many combined digital functions, but lack the ability to operate individually and independently when decoupled from each other. Furthermore, these products also likely fail to coordinate with other peripheral devices in a logical manner.

Although there are products such as laptop computers and cordless home phones that activate when separated from their docking stations or charging cradles or base stations, these products are not worn by a user nor do they include peripherals that operate independently and automatically activate when they decouple from their host devices.

### SUMMARY OF THE INVENTION

An electronic product in accordance with several embodiments of the present invention can take the form of a combination of a host device such as a one-way or two-way communication product and one or more additional peripherals that selectively couple and decouple from the communication product. Either the host device or the peripheral or both can be worn by a user. The one or more peripherals can operate either independently or in coordination with the host device. Note that any combination of peripheral devices can operate concurrently and independently with their own separate relationship to the electronic host device. Also note that the host device and the peripherals can be any electronic product such as an earphone or earpiece, a display, a microphone, a user interface, a keyboard, a phone, a pager, a personal digital assistant, a camera, a watch, a computer, a receiver, and a transmitter.

In one embodiment of the present invention, an electronic product includes an electronic host device, at least one peripheral device that selectively couples and decouples to the electronic host device and activates independently of the electronic host device (when de-coupled from the host device) and operates independently of other peripheral devices, The electronic product can also include means for wearing the electronic product by a user. The peripheral device can activate automatically upon being decoupled from the electronic host device and can also activate independently of any other peripheral device or alternatively operate concurrently and synergistically with at least another peripheral device. In this regard, the peripheral device can automatically sense the need for its own power source to become active and can optionally automatically sense the need for activating a new wireless link to the electronic host device using its own power source when selectively decoupled from the electronic host device.

In a second embodiment of the present invention, an electronic host device forming a portion of an electronic product can include a power source, one or more ports for receiving at least two peripheral devices that can independently and selectively couple and decouple to the electronic host device and activates independently of the electronic host device and other peripheral devices, and optionally includes a means for being worn by a user

In a third embodiment of the present invention, a peripheral device forming an electronic product in conjunction with an electronic host device can include a power source, and a port for coupling with the electronic host device. The peripheral device can selectively couple and decouple to the at least one electronic host device and activates independently of the electronic host device and other peripheral devices that work in conjunction with the electronic host device. The peripheral electronic product can also include a means for being worn by a user on at least one among the electronic host device and the peripheral device.

In yet another embodiment, a method of operating at least one peripheral device independently from a electronic host device can include the steps of powering the electronic host device and the at least one peripheral device using a power source for the electronic host device when the at least one peripheral device is coupled to the electronic host device, detecting a selective decoupling of at least one peripheral device from the electronic host device, and powering the electronic host device using the power source for the electronic host device and independently powering at least one peripheral device with a power source for the peripheral device in response to detecting the selective decoupling. The method can further include the step of wearing at least one among the peripheral device and the electronic host device on a user. The method can also include the step of automatically activating the peripheral device upon being decoupled from the electronic host device. Note that the peripheral device can activate independently of any other peripheral device (or devices) and that any combination of peripheral devices can operate concurrently and independently with their own separate relationship to the electronic host device. Note that any combination of peripheral devices can also operate synergistically with the electronic host device. Optionally, the method can further include the step of activating a new wireless link between the electronic host device and at least one peripheral device in response to detecting the selective decoupling from the electronic host device.

### BRIEF DESCRIPTION OF THE DRAWINGS

FIG. 1 is a block diagram of a wearable electronic product or system in accordance with the present invention.

FIG. 2 is a wearable electronic product in accordance with the present invention.

FIG. 3 illustrates a peripheral device disengaging from a host device of the wearable electronic product of FIG. 2 in accordance with the present invention.

FIG. 4 illustrates the wearable electronic product of FIG. 2 with the peripheral device fully disengaged from the host device in accordance with the present invention.

FIG. 5 is a flow chart illustrating a method of operating at least one peripheral device independently from a electronic host device in accordance with the present invention.

### DETAILED DESCRIPTION OF THE DRAWINGS

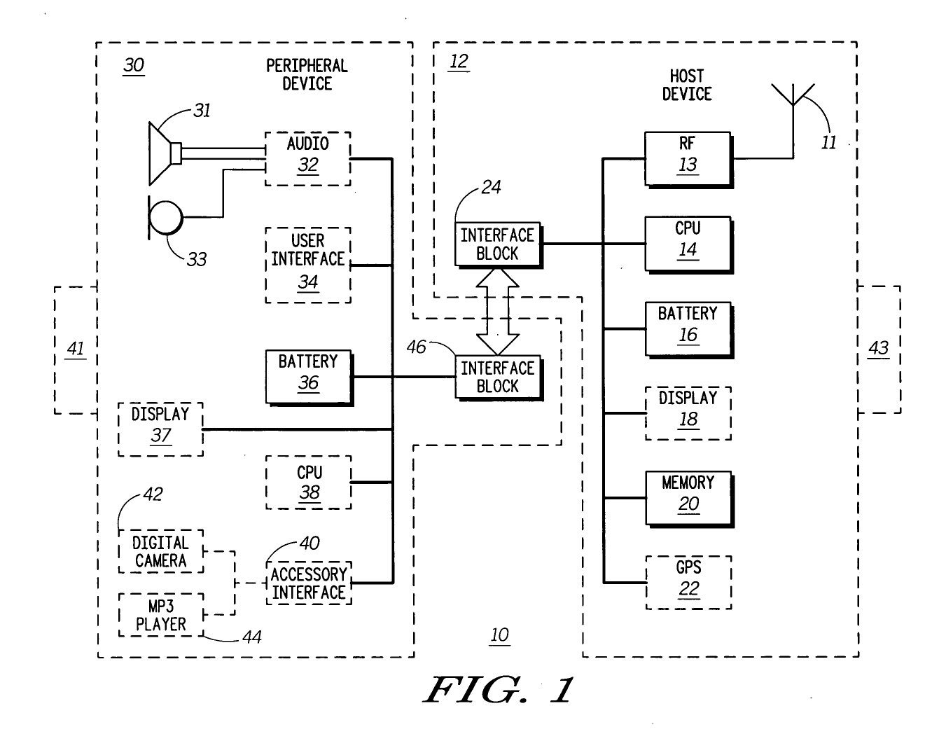

Referring to FIG. 1, a block diagram of an electronic product 10 in the form of a communication product is shown. The product 10 can include a host device 12 and a peripheral device 30. The host device 12 can include, for example, a radio frequency (RF) module 13 such as those found in conventional cellular phones, a two-way trunked radio, a home cordless phone, a two-way paging device, a satellite phone, or a Motorola iDEN phone, or any number of other communication devices. The RF module can include an encoder, transmitter as well as a receiver and decoder for receiving and decoding information sent to the adaptable communication module 12. The host device 12 can further include an antenna 11, a processor 14 such as a microprocessor and a memory 20. The host device 12 can also include a power source or battery 16, a presentation device 18 such as a display and a GPS receiver 22 useful for location tracking. The display can be coupled to a graphical user interface program or driver (not shown). The host device 12 can further include an interface block 24 (which may connect directly to the peripheral device either by direct contact attachment, or wirelessly).

Referring once again to FIG. 1, the host device 12 can be any number of products and take on any number of form factors. For example, the host device can be a monolith phone, a flip phone, a wristwatch communicator, a camera phone, a video phone, a qwerty key-board host device, a pendant-shaped host device, an MP3 player sport device, a heart rate monitor, a game controller host, or a toy to name a few. Please note that the host and peripheral devices are not limited to communication products and these are just presented as exemplary components that can comprise a wearable electronic product.

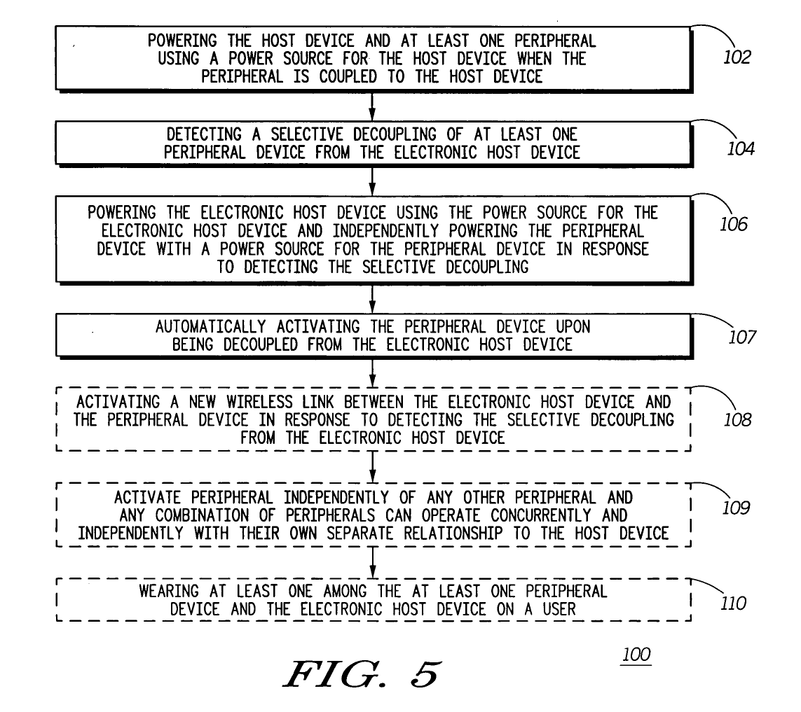

The peripheral device 30 can include a power source 36 such as a battery, a user interface 34, and a second interface block 46 for interfacing with the interface block 24 of the host device 12. The interface blocks 24 and 46 can connect to each other by direct contact, wirelessly or in any other manner. Optimally, this embodiment can enable a direct physical connection of the host and peripheral devices and subsequently optionally include data signal interfacing if desired, and only require “docking” for power re-charging. Conversely, when the peripheral device is dis-engaged from its “docked” position adjacent to the host, the peripheral device can “wake-up” and acknowledge that it can (1) turn-on, and (2) begin a steady flow of data, while (3) simultaneously initiating the wireless link required to facilitate this transmission of data (See FIG. 5). The peripheral device 30 can optionally include a presentation and/or input device such as an audio module 32 coupled to speaker 31 and microphone 33 and optionally a display 37. The peripheral device 30 can also optionally include an accessory interface 40 and a plurality of accessories such as a digital camera 42 or an MP3 player 44 as examples. As previously mentioned, the host device 12 can be one among a plurality of host devices having different user interfaces and the processor 14 is adaptable to control the different user interfaces when the first interface block 24 recognizes the second interface block 46 of a given peripheral device.

Thus, as presented, the host electronic device 12 can provide the core functionality of the wearable electronic product 10 and can be thought of as an engine that powers any number of interface module devices or peripherals (camera, gaming console, phone, MP3 player, PDA, etc.) that are in effect different chassis for the engine. The host electronic device 12 can conform to the user's preference, lifestyle or specific activity the user is performing. Of course, in one embodiment, rather than spending duplicative costs for a core function that can be modular, a single core device can be adapted to be used with a plurality of host devices or accessories or peripherals. Finally, note that either the peripheral device 30 or the host device 12 can include a means (41 or 43) for being worn by a user. The means 41 or 43 can be a belt clip, a hook and loop fastener, a belt, or any other form of strap commonly used to couple portable consumer products to users. Of course, other more rigid and more permanent means of being worn by a user can also be used, including tags, anklets or bracelets used for in-house detainees or for tracking animals.

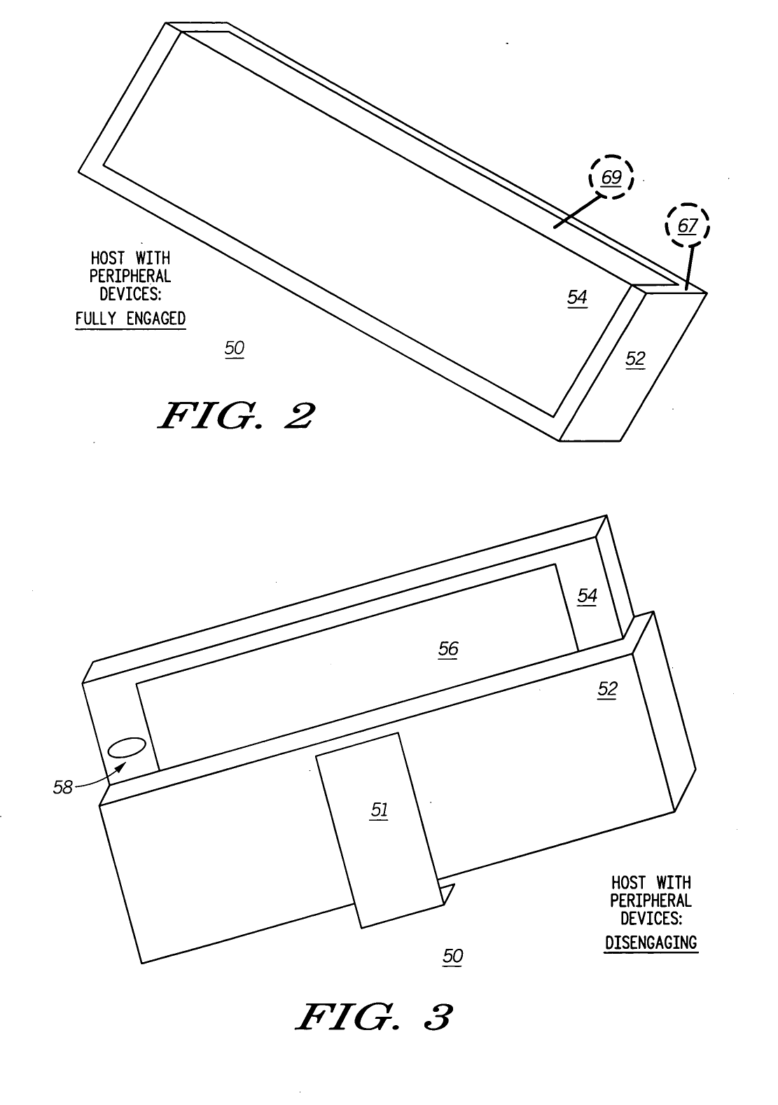

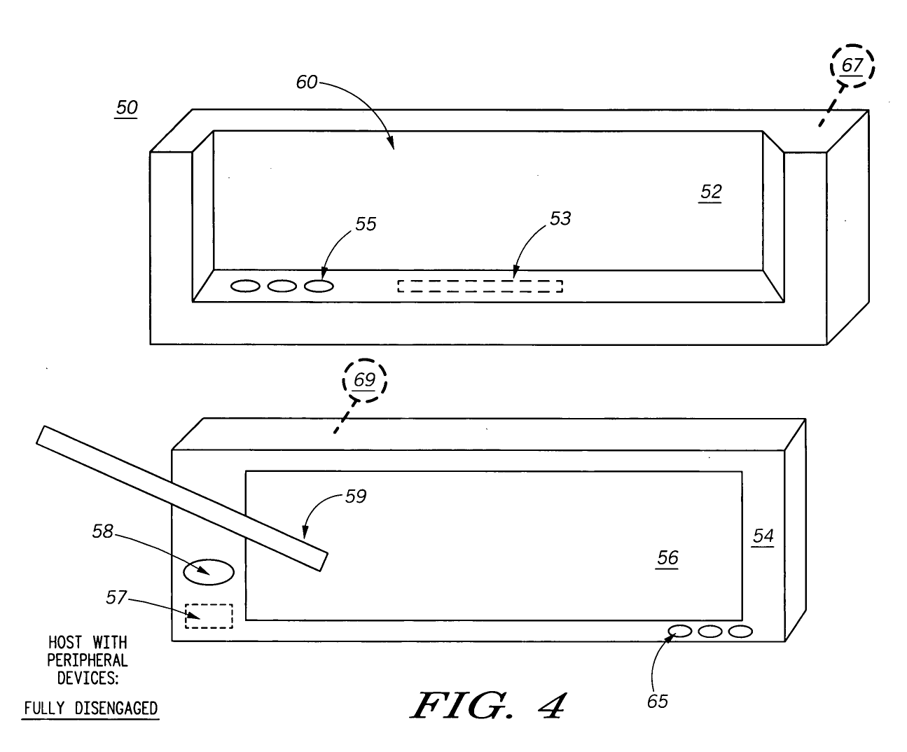

Referring to FIG. 2, an exemplary electronic product 50 is shown having a peripheral device 54 fully engaged with an electronic host device 52. Assuming the appropriate form factors, the peripheral device 54 can simply slide into whichever host device (or vice-versa) the user wants to use for a given time or activity. The electronic product 50 can also include other peripherals such as earbuds 67 and 69. Earbud 67 can be selectively coupled and decoupled from the host device 52 while earbud 69 can be selectively coupled and decoupled from the peripheral device 54. Peripheral device 54 will activate and operate independently of the other peripheral devices, but can work synergistically with such devices. For example, the earbud 69 can operate with the peripheral device 54 independent of the host device 52 but can alternatively work with both the host device 52 and the peripheral device 54. Referring to FIG. 3, a rear perspective view of the wearable electronic product 50 is shown with the peripheral device 54 disengaging from the electronic host device 52. The peripheral device 54 can be enclosed in a housing having an optional display 56 and optionally a means 58 such as a switch or button for manually activating the peripheral device 54. In this example, the means for being worn by a user takes the form of a belt clip 51, although other forms of attaching to a user is certainly contemplated as explained above.

Referring to FIG. 4, the wearable electronic product 50 is shown with the peripheral device 54 fully disengaged from the host device 52. As shown, the host device 52 can include a port area 60 that can include interface contacts 55 and a power source such as battery 53. In this embodiment, the peripheral device 54 can function as a PDA including a touch sensitive display 56 and a stylus 59 used for writing on the display 56. The peripheral device 54 can also include its own power source such as battery 57 and corresponding interface contacts 65 which can mate with contacts 55 when the peripheral and the host devices are engaged. The wearable electronic product illustrated in FIGS. 2-4 is merely a single example of the many configurations for the wearable electronic product 50.

Referring to FIG. 5, a flow chart illustrating a method 100 of operating at least one peripheral device independently from a electronic host device can include the step 102 of powering the electronic host device and the at least one peripheral device using a power source for the electronic host device when the peripheral device is coupled to the electronic host device and the step 104 of detecting a selective decoupling of the peripheral device from the electronic host device. The method 100 can further include the step 106 of powering the electronic host device using the power source for the electronic host device and independently powering the peripheral device with a power source for the peripheral device in response to detecting the selective decoupling. The method 100 can also include the step 107 of automatically activating the peripheral device upon being decoupled from the electronic host device and the optional step 108 of activating a new wireless link between the electronic host device and the at least one peripheral device in response to detecting the selective decoupling from the electronic host device. Note that the peripheral device can activate independently of any other peripheral device and that any combination of peripheral devices can operate concurrently and independently with their own separate relationship to the electronic host device at step 109. The method further includes the step 10 of wearing at least one among the at least one peripheral device and the electronic host device on a user. For example, a wearable electronic device having a cellular phone as a host device and a PDA as a peripheral device can have either a belt clip or other attachment means on the cellular phone or the PDA or both. Operationally, once disengagement of the PDA from the cellular phone is detected, the PDA can automatically power-up and operate independently of the cellular phone and can optionally work in conjunction with the cellular phone by also having a new wireless link created between the PDA (peripheral) and the cellular phone (host) once disengagement is detected. Furthermore, other peripheral devices can also activate and/or operate independently and concurrently from the host device. For example, an earpiece (having a Bluetooth transceiver for example) for the cellular phone can power-up independently from the cellular phone and operate as an earpiece for an FM radio or an MP3 player (also having Bluetooth transceivers) when such other peripheral devices are operating independently from the host device.

In light of the foregoing description, it should be recognized that embodiments in accordance with the present invention can be realized in hardware, software, or a combination of hardware and software. A communications system or device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

Additionally, the description above is intended by way of example only and is not intended to limit the present invention in any way, except as set forth in the following claims.

1. An electronic product, comprising:
an electronic host device; and
at least one peripheral device that selectively couples and decouples to the electronic host device and activates independently of the electronic host device and further activates and operates independently of other peripheral devices that selectively couple and decouple to the electronic host device.

2. The electronic product of claim 1, wherein the electronic device further comprises a means for wearing the wearable electronic product on at least one among the electronic host device and the at least one peripheral device on a user.

3. The electronic product of claim 1, wherein the at least one peripheral device activates automatically upon being decoupled from the electronic host device.

4. The electronic product of claim 1, wherein the at least one peripheral device activates independently of any other peripheral device for the electronic host device.

5. The electronic product of claim 1, wherein the at least one peripheral device automatically senses the need for its own power source to become active when selectively decoupled from the electronic host device.

6. The electronic product of claim 1, wherein the at least one peripheral device automatically senses the need for activating a new wireless link to the electronic host device using its own power source when selectively decoupled from the electronic host device.

7. The electronic product of claim 1, wherein the at least one peripheral device can be selected among the group of peripherals comprising an earpiece, a display, a microphone, a user interface, a keyboard, a phone, a pager, a personal digital assistant, a camera, a watch, a computer, a receiver, and a transmitter.

8. The electronic product of claim i, wherein any combination of peripheral devices operates concurrently and independently with their own separate relationship to the electronic host device.

9. An electronic host device forming a portion of an electronic product, comprising:
a power source;
at least one port for receiving at least two peripheral devices that independently and selectively couple and decouple to the electronic host device and activate independently of the electronic host device and other peripheral devices.

10. A peripheral device forming an electronic product in conjunction with an electronic host device, comprising:
a power source;
a port for coupling with at least one electronic host device, wherein the peripheral devices selectively couple and decouple to the at least one electronic host device and activates independently of the electronic host device and other peripheral devices that work in conjunction with the electronic host device.

11. The peripheral device of claim 10, wherein the peripheral device activates automatically upon being decoupled from the electronic host device.

12. The peripheral device of claim 10, wherein the peripheral device automatically senses the need for its own power source to become active when selectively decoupled from the electronic host device.

13. The peripheral device of claim 10, wherein the peripheral device automatically senses the need for activating a new wireless link to the electronic host device using its own power source when selectively decoupled from the electronic host device.

14. The peripheral device of claim 10, wherein the peripheral device can be selected among the group of peripherals comprising an earpiece, a display, a microphone, a user interface, a keyboard, a phone, a pager, a personal digital assistant, a camera, a watch, a computer, a receiver, and a transmitter.

15. The peripheral device of claim 14, wherein any combination of peripheral devices operates concurrently and independently with their own separate relationship to the electronic host device.

16. A method of operating at least one peripheral device independently from an electronic host device, comprising the steps of:
powering the electronic host device and the at least one peripheral device using a power source for the electronic host device when the at least one peripheral device is coupled to the electronic host device;
detecting a selective decoupling of the at least one peripheral device from the electronic host device;
powering the electronic host device using the power source for the electronic host device and independently powering the at least one peripheral device with a power source for the at least one peripheral device in response to detecting the selective decoupling; and
activating the peripheral device independently of any other peripheral device coupled to at least one among the electronic host device and the peripheral device.

17. The method of claim 16, wherein the method further comprises the step of wearing at least one among the at least one peripheral device and the electronic host device on a user.

18. The method of claim 16, wherein the method further comprises the step of automatically activating the peripheral device upon being decoupled from the electronic host device.

19. The method of claim 16, wherein the method further comprises the step of activating a new wireless link between the electronic host device and the at least one peripheral device in response to detecting the selective decoupling from the electronic host device.

20. The method of claim 16, wherein the method further comprises the step of operating any combination of peripheral devices concurrently and independently with their own separate relationship to the electronic host device.
